(19) United States
(12) Patent Application Publication
(10) Pub. No.: US 2008/0253643 A1
(43) Pub. Date: Oct. 16, 2008

(54) Component inspection imaging apparatus structure

(76) Inventor: Chun-Nan Wu, Kaohsiung County (TW)

Correspondence Address: Joe McKinney Muncy, PO Box 1364, Fairfax, VA, 22038-1364, US

(21) Appl. No.: 11/785,026

(22) Filed: Apr. 13, 2007

(51) Int. Cl. G06K 9/00

(52) U.S. Cl. 382/147

(57) ABSTRACT

An improved component inspection imaging apparatus structure comprises a component inspection imaging apparatus, a component retaining turntable and a plurality of image capturing devices. The component inspection imaging apparatus comprises an extension tube fixing rack, an extension tube, a mirror extending rack, a mirror fixing rack and a conical mirror. A mirror plane portion is disposed on an internal side of the conical mirror, and an inspecting component is put onto the component retaining turntable and rotated under the component inspection imaging apparatus. The component inspection imaging apparatus covers the inspecting component for inspection. An image of the surrounding at the head of the inspecting component is formed at the mirror plane portion in the conical mirror. The image capturing device at the top of the component inspection imaging apparatus captures an image of the head of the inspecting component from top to bottom to determine a defective component quickly.

### FIELD OF THE INVENTION

The present invention relates to an improved component inspection imaging apparatus structure, and more particularly to a component inspection image apparatus structure capable of inspecting a component more accurately and quickly by the principle of a mirror image.

### BACKGROUND OF THE INVENTION

Most conventional component inspection imaging apparatuses are used for inspecting the quality of screws, but these component inspection imaging apparatuses still have the following shortcomings in their practical applications:

1. A conventional component inspection imaging apparatus as shown in FIGS. 1 and 2 includes an image capturing device 20a installed to a lateral side of an inspecting component 10a, such that the image capturing device 20a can inspect the image on one side of the inspecting component 10A only, and such conventional component inspection imaging apparatus has the drawback of unable to definitely identify the quality of the inspecting component.

2. Another conventional component inspection imaging apparatus as shown in FIGS. 3 and 4 includes an image capturing device 20b installed on the top of an inspecting component 10b, such that the image capturing device 20b can capture the image of the top surface of the inspecting component 10b, and thus having the drawback of unable to identify any defect occurred at a position around the top of the inspecting component 10b.

### SUMMARY OF THE INVENTION

Therefore, it is a primary objective of the present invention to provide an improved component inspection imaging apparatus structure for enhancing the accuracy and integrity of a component inspection.

To achieve the foregoing objective, the present invention provides an improved component inspection imaging apparatus structure comprising a component inspection imaging apparatus, a component retaining turntable and a plurality of image capturing devices; wherein the component inspection imaging apparatus is comprised of an extension tube fixing rack, an extension tube, a mirror extending rack, a mirror fixing rack and a conical mirror. The conical mirror has a mirror plane portion formed on its internal side for completely reflecting every angle of the inspecting component, and uses the image capturing devices installed at the top of the component inspection imaging apparatus and the lateral sides of the inspecting component respectively to obtain a complete screen of the inspecting component for determining the position of any defect and the quality of the inspecting component, and the inspecting component can be any component such as a screw.

### BRIEF DESCRIPTION OF THE DRAWINGS

FIG. 1 is a perspective view of a prior art;

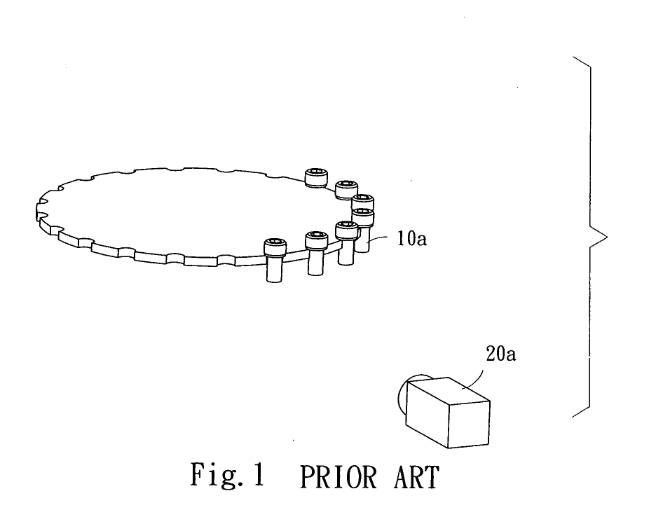

FIG. 2 is a side view of FIG. 1;

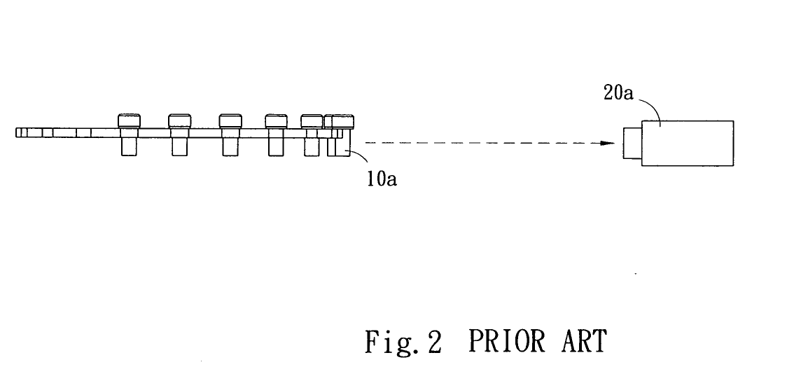

FIG. 3 is a perspective view of another prior art;

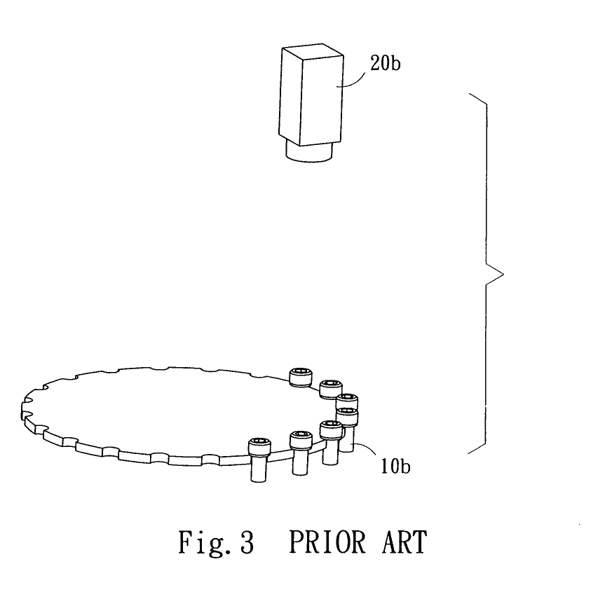

FIG. 4 is a side view of FIG. 3;

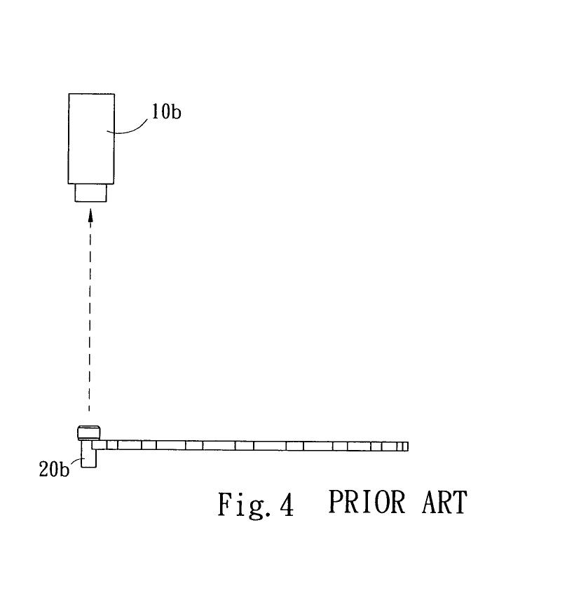

FIG. 5 is a perspective view of the present invention;

FIG. 6A is a first schematic view of movements performed in accordance with the present invention;

FIG. 6B is a second schematic view of movements performed in accordance with the present invention;

FIG. 6C is a third schematic view of movements performed in accordance with the present invention;

FIG. 7 is a cross-sectional view of a component inspection imaging apparatus in accordance with the present invention;

FIG. 8 is a side view of a component inspection imaging apparatus in accordance with the present invention;

FIG. 9 is a first schematic view of imaging in accordance with the present invention;

FIG. 10 is a second schematic view of imaging in accordance with the present invention; and

FIG. 11 is a schematic view of the movements of a conical mirror used for inspecting a rear end of a screw of an inspecting component in accordance with the present invention.

### DETAILED DESCRIPTION OF THE PREFERRED EMBODIMENTS

The present invention will now be described in more detail hereinafter with reference to the accompanying drawings that show various embodiments of the invention.

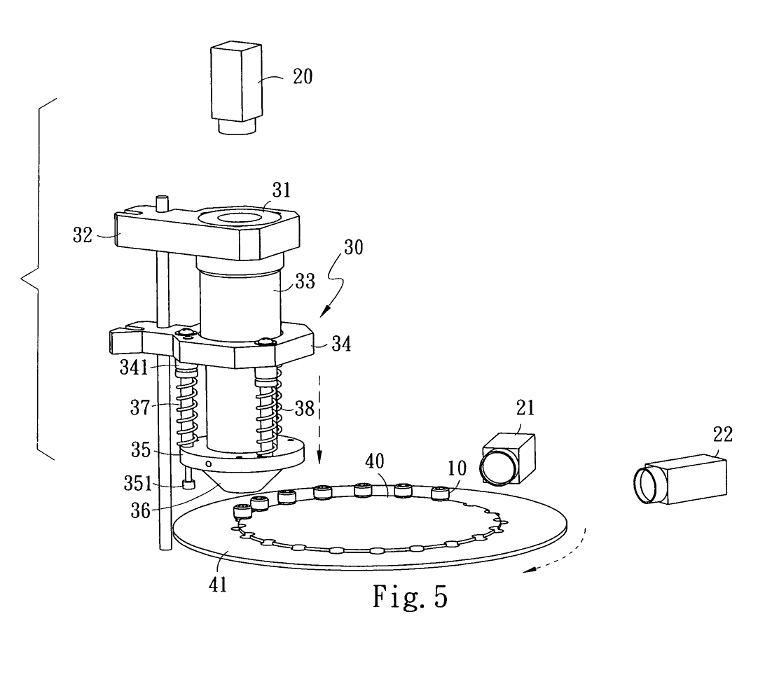

Referring to FIGS. 5, 6A and 7, the improved component inspection imaging apparatus structure comprises a component inspection imaging apparatus 30, a component retaining turntable 40 and image capturing devices 20, 21, 22; wherein the component inspection imaging apparatus 30 is comprised of an annular light source 31, an extension tube fixing rack 32, an extension tube 33, a mirror extending rack 34, a mirror fixing rack 35, a conical mirror 36, a plurality of positioning pins 37 and a plurality of springs 38; wherein a mirror plane portion 361 is formed on the internal side of the conical mirror 36 for completely reflecting every angle of the inspecting component 10, and an angle defined by engaging both ends of the conical mirror 36 allows an image reflected from the internal side of the conical mirror 36 and identified easily by the image capturing device 20 or directly by visual inspection, and the mirror extending rack 34 includes a bushing 341 thereon, and a positioning pin 37 is passed into the bushing 341 and the spring and inserted into the mirror fixing rack 35, and a push spacing pillar 351 is disposed at the bottom of the mirror fixing rack 35.

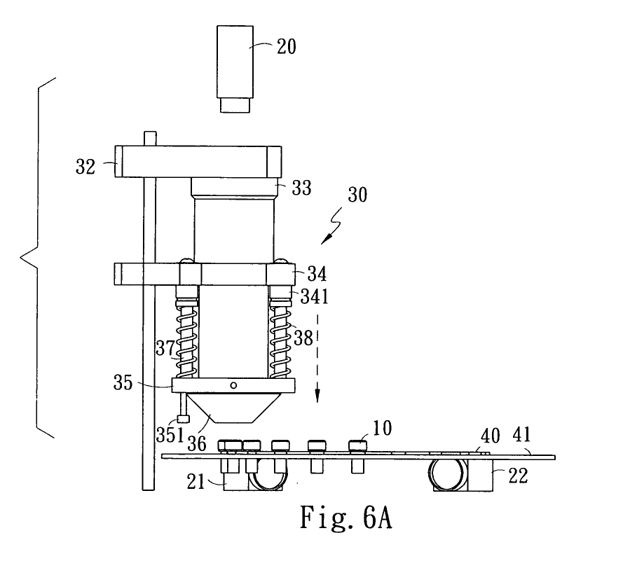

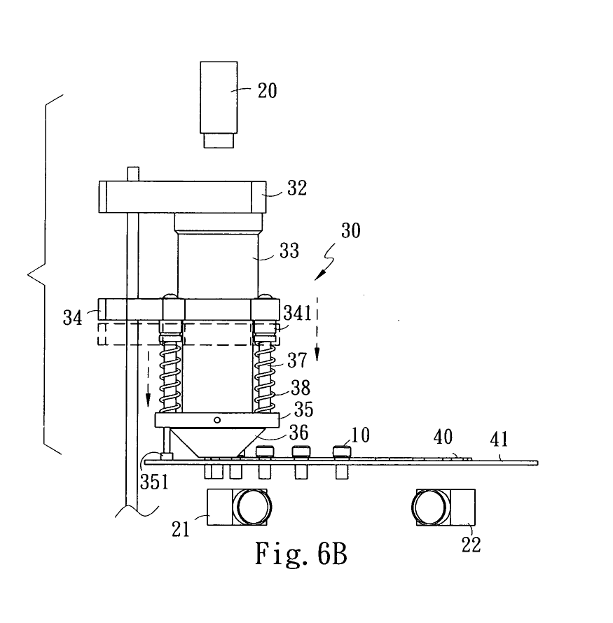

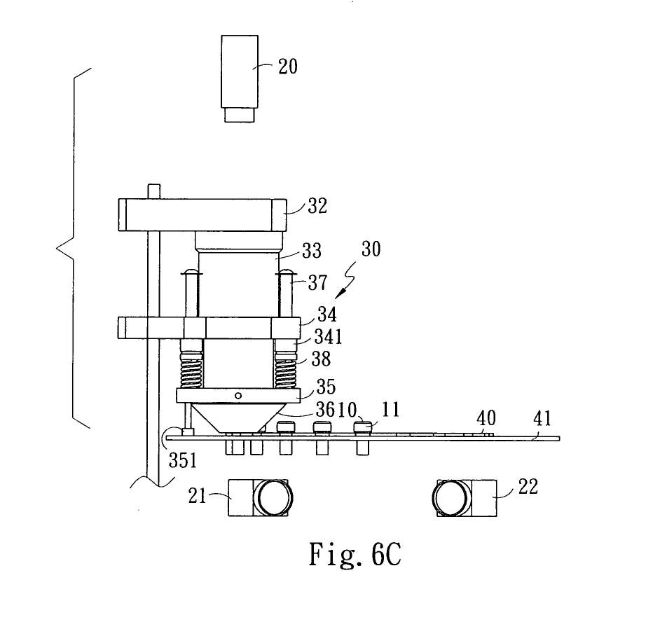

Referring to FIGS. 6A, 6B and 6C for the inspection of an inspecting component 10, the inspecting component 10 is put on a component retaining turntable 40 and rotated sequentially under the component inspection imaging apparatus 30, and the component inspection imaging apparatus 30 descends and covers the desired inspecting component 10 and pushes a spacing pillar 351 under the conical mirror 36, and the mirror fixing rack 35 presses against the inspection platform 41 to make sure that the conical mirror 36 is covered onto the inspecting component 10. If the component inspection imaging apparatus 30 continues descending, then only the mirror extending rack 34 will descend, such that the bushing 341 on the mirror extending rack 34 compresses the spring 38 only, without directly pressing the conical mirror 36 and the inspection platform 41, and the inspecting component 10 can be any component such as a screw.

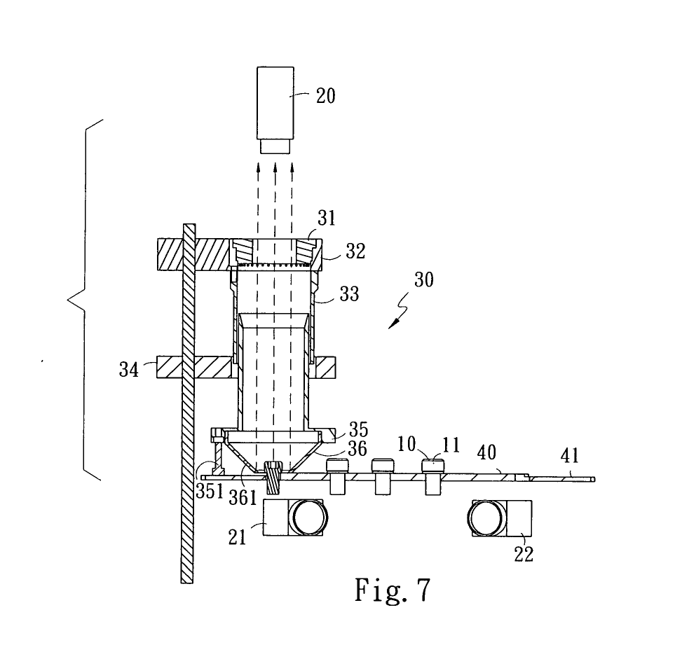

Referring to FIGS. 6C and 7, if the component inspection imaging apparatus 30 is covered onto the inspecting component 10, the mirror plane portion 361 disposed on the internal side of the conical mirror 36 will form an image of the surrounding of a head portion 11 of the inspecting component 10 on the internal mirror plane portion 361 of the conical mirror 36. Now, the image capturing device 20 at the top of the component inspection imaging apparatus 30 will capture the image of the head portion 11 of the entire inspecting component 10 from top to bottom, and an the annular light source 31 at the upper end of the component inspection imaging apparatus 30 will illuminate the extension tube 33 and the conical mirror 36, such that the images of the head portion 11 of the inspecting component 10 and its surrounding captured by the image capturing device 20 will be clearer.

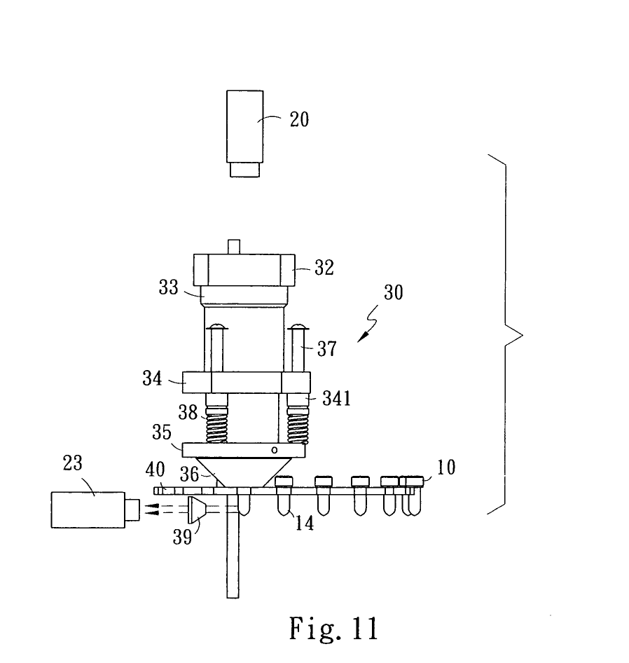

Referring to FIG. 11, if a rear thread end 14 of the inspecting component 10 comes with a special structure such as a cut rear groove, the conical mirror 39 can be installed separately to a side of the inspecting component 10 and at a position perpendicular to the component inspection imaging apparatus 30 and under the inspection platform 41, and an image capturing device 23 is installed on a lateral side of the conical mirror 39 for capturing an image of the rear thread end 14 of the inspecting component 10 by the image capturing device 23.

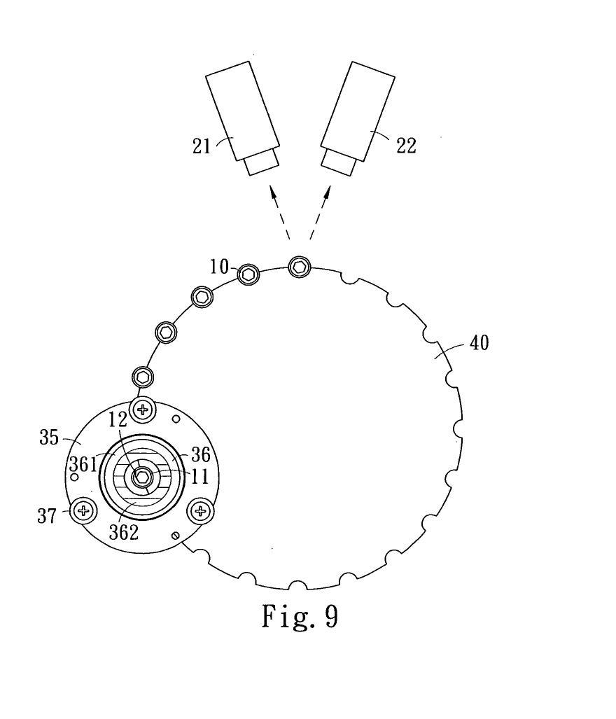

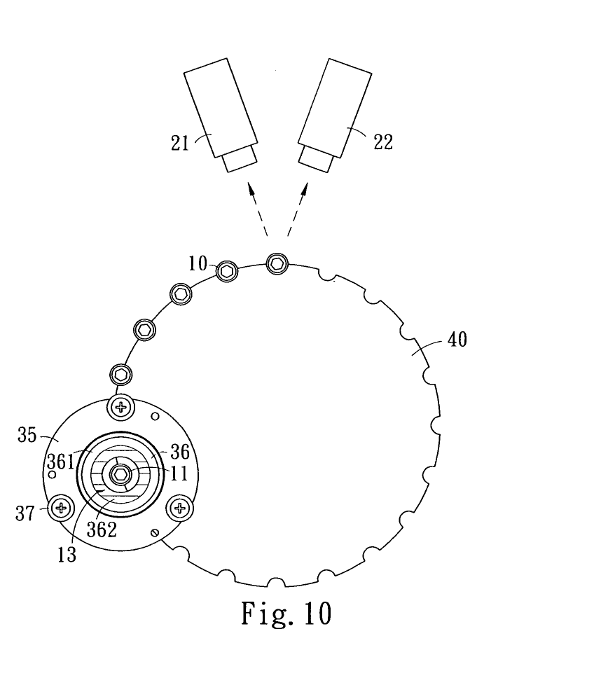

Referring to FIGS. 9 and 10, the image capturing device 20 installed at the top of the component inspection imaging apparatus 30 can capture the image at the surface of the head 11 of the inspecting component 10 immediately, and thus if there is a flaw 12 on the surface of the head 11 of the inspecting component 10, the flaw 12 can be identified immediately. If a flaw 13 occurs at the surrounding of the head 11 of the inspecting component 10, then an image 362 captured and reflected directly from the mirror plane portion 361 of the conical mirror 36 can be used for the inspection to determine the flaws 12, 13 of the head 11 of the inspecting component 10 by the entire image capturing device 20 installed at the top of the component inspection imaging apparatus 30.

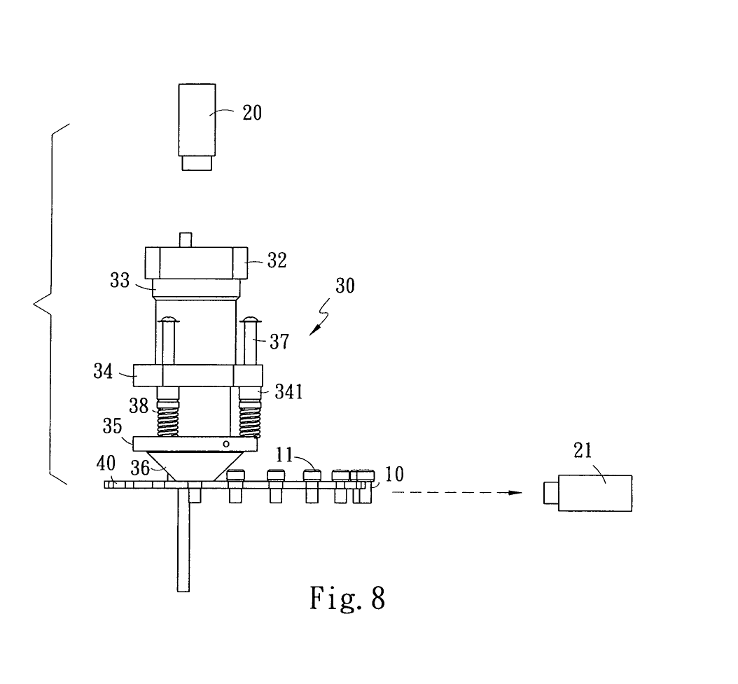

Referring to FIG. 8, after the image capturing device 20 installed at the top of the component inspection imaging apparatus 30 captures the image of the entire head 11 of the inspecting component 10, the component inspection imaging apparatus 30 will rise, such that the component retaining turntable 40 will turn the inspecting component 10 towards another direction, and the image capturing devices 21, 22 installed on a lateral side of the component retaining turntable 40 can capture the image of a lateral side of the inspecting component 10. With the image of the head 11 of the inspecting component 10 captured by the image capturing device 20 installed at the top of the component inspection imaging apparatus 30, the quality of the entire inspecting component 10 as well as the flaws 12, 13 can be determined.

What is claimed is:

1. An improved component inspection imaging apparatus structure, at least comprising a component inspection imaging apparatus, a component retaining turntable and a plurality of image capturing devices, and said component inspection imaging apparatus being comprised of an annular light source, an extension tube fixing rack, an extension tube, a mirror extending rack, a mirror fixing rack, a conical mirror, a plurality of positioning pins and a plurality of springs, and said mirror extending rack having a bushing for passing a positioning pin into a bushing and a spring and inserting said positioning pin into said mirror fixing rack, and said mirror fixing rack installing a push spacing pillar disposed at the bottom of said mirror fixing rack; wherein both ends of said conical mirror are engaged to define an included angle, and a mirror plane portion disposed on the internal sides of said included angle.

2. The improved component inspection imaging apparatus of claim 1, wherein said included angle defined by engaging both ends of said conical mirror allows an image to be reflected from said mirror plane portion and identified by said image capturing device or directly by visual inspection.

3. The improved component inspection imaging apparatus of claim 1, wherein said conical mirror is used independently for inspecting other positions and characteristics of an inspecting component.

4. The improved component inspection imaging apparatus of claim 3, wherein said inspecting component is a screw.
